(19) United States
(12) Patent Application Publication
(10) Pub. No.: US 2016/0263666 A1
(43) Pub. Date: Sep. 15, 2016

(54) CUTTING MEMBER WITH COOLANT DELIVERY

(71) Applicant: Kennametal Inc., Latrobe, PA (US)

(72) Inventors: Neal S. Myers, Greensburg, PA (US); Pankaj Mehrotra, Greensburg, PA (US)

(21) Appl. No.: 14/645,674

(22) Filed: Mar. 12, 2015

(51) Int. Cl. B23B 51/06; B23C 5/28; B23C 5/10

(52) U.S. Cl. CPC B23B 51/06; B23C 5/10; B23C 5/28; B23B 2250/12; B23B 2222/28; B23C 2210/03; B23C 2222/28; B23C 2250/12

(57) ABSTRACT

A cutting member with coolant delivery that has a cutting member body with an axial forward end and an axial rearward end. The cutting member body has a shank portion adjacent the axial rearward end thereof and a cutting portion adjacent to the axial forward end. The cutting member body contains a coolant delivery passage wherein the coolant delivery passage comprises a primary cavity in the shank portion and a central coolant passage in the cutting portion and a plurality of lateral coolant passages in the cutting portion. The lateral coolant passages are a communication with the primary cavity through the central coolant passage. Each of the lateral coolant passages has an open end through which coolant exits the cutting member. The cutting portion is of a first grade of hard material, and the shank portion is of a second grade of hard material wherein the first grade of hard material is different from the second grade of hard material.

### BACKGROUND OF THE INVENTION

The present invention pertains to a cutting member with coolant delivery, as well as a composite rod blank that can be processed into a cutting member with coolant delivery. More specifically, the present invention pertains to a cutting member, such as for example, a drill or end mill, with coolant delivery, as well as a composite rod blank that can be processed into a cutting member with coolant delivery, wherein coolant exits the cutting member in the vicinity of the axial forward end thereof. The composite rod blank can be made by injection molding or cold iso-static pressing depending upon the particular article.

End mills are rotary tools that are used for machining many types of materials, from metals to plastics. An end mill typically has an elongate shape with an axial forward end and an axial rearward end. An end mill has a shank portion, which is generally cylindrical, is adjacent the axial rearward end and functions to support the end mill whereby the shank portion is adapted to be removably gripped by a motor driven chuck or functionally similar device. The end mill further has a cutting portion that is located axial forward of the shank portion and is adjacent the axial forward end of the end mill. The cutting portion contains cutting edges separated by flutes which are useful to evacuate chips away from the vicinity where the cutting edges contact the workpiece. Further, all of the flutes or a part of the flutes are also used as cutting edges in end mills.

Some end mills utilize coolant to facilitate the material removal operation. It is beneficial to apply the coolant such as, for example, via a spray at the interface of the end mill and the workpiece. Therefore, it would be highly desirable to provide a cutting member such as, for example an end mill (as well as a composite rod blank that can be processed into an end mill) wherein a coolant spray impinges the interface of the cutting member and the workpiece. The use of injection molding techniques or cold iso-static pressing techniques to produce a composite rod blank that can be processed into the cutting member allows for the formation of a plurality of lateral coolant passages that split away from the central coolant passage in the vicinity of the axial forward end of the body of the injection molded (or cold iso-statically pressed) end mill or drill (i.e., cutting member) with coolant delivery. This feature enhances the ability of the injection molded (or cold iso-statically pressed) end mill or drill (i.e., cutting member) with coolant delivery to deliver coolant to the interface of the cutting member and the workpiece.

A cutting member like an end mill or drill include a cutting portion, which typically has cutting edges separated by flutes or presents some complex geometry to perform the cutting function. The cutting member also has a shank portion that is removably gripped by a driver such as, for example, a motor driven chuck or functionally similar device. The shank portion does not require a complex geometry like the more complex geometry for the cutting portion. There should also be an appreciation that the use of the injection molding process or a cold isostatic process provides for the formation of flutes or cutting edges at the axial forward end of the composite rod blank that can be processed into the injection molded end mill (or cutting member) with coolant delivery while leaving the portion adjacent the axial rearward end generally smooth. The use of an injection molding process or a cold isostatic process to produce the composite rod blank that can be processed into the cutting member provides an advantage of requiring only finish grinding of the outer geometry without the need to significantly grind any of the shank portion. For the sake of precision in holding, the shank portion will need to be finish ground at least to some extent. Overall, there will be a reduction in labor and materials to produce the cutting member.

By using an injection molding technique to produce the injection molded composite rod blank that can be processed into a cutting member (e.g., an end mill) with coolant delivery, the coolant delivery passage located in the shank portion can optionally have a larger volume than the coolant delivery passage located in the cutting portion. This results in a reduction of the amount of material necessary to make the cutting member with coolant delivery so as to reduce the material costs. The presence of the coolant delivery passage located in the shank portion with a larger volume also results in faster binder removal during the post-injection molding processing thereby reducing the cost to produce the cutting member. Similar advantages regarding material usage and binder removal exist for a cutting member (e.g., a drill) in which the coolant delivery passage has a larger volume. Further, like advantages exist by using a cold isostatic pressing technique to produce the cold iso-static pressed cutting member with coolant delivery.

The cutting portion of the cutting member with coolant delivery performs a different function than the shank portion. This means that the material requirements for the cutting portion are different from those for the shank portion. The use of an injection molding technique or a cold isostatic pressing technique will allow for the use of different grades of hard material (e.g., cemented (cobalt) tungsten carbide) for the cutting portion and the shank portion. By using different grades of hard material, the cutting portion can be produced from a more costly premium cemented (cobalt) tungsten carbide, which is more suitable for cutting; and the shank portion can be produced from a less costly grade of cemented (cobalt) tungsten carbide. The less costly grade of cemented (cobalt) tungsten carbide is sufficiently adequate to function as the shank portion. The result is that the more costly material is used to produce the portion (i.e., the cutting portion) that needs the properties of the more costly material and the less costly material is used to produce the portion (i.e., shank portion) that does not need the properties of the more costly material. By using an injection molding technique or a cold isostatic pressing technique, the material usage can be more customized to the specific function of the specific portion of the cutting member.

### SUMMARY OF THE INVENTION

In one form thereof, the invention is a cutting member with coolant delivery. The cutting member comprises a cutting member body that has an axial forward end and an axial rearward end, as well as a central longitudinal axis. The cutting member body has a shank portion adjacent the axial rearward end thereof and a shank exterior surface. The cutting member body has a cutting portion adjacent to the axial forward end thereof and a cutting exterior surface containing one or more cutting edges. The cutting member body contains a coolant delivery passage wherein the coolant delivery passage comprises a primary cavity in the shank portion and a central coolant passage in the cutting portion and a plurality of lateral coolant passages in the cutting portion. The lateral coolant passages are a communication with the primary cavity through the central coolant passage. Each of the lateral coolant passages has an open end through which coolant exits the cutting member. The cutting portion is of a first grade of hard material, and the shank portion is of a second grade of hard material wherein the first grade of hard material is different from the second grade of hard material.

In yet another form thereof, the invention is a cutting member with coolant delivery wherein the cutting member is useful for material removal from a workpiece. The cutting member comprises a cutting member body that has an axial forward end and an axial rearward end, as well as a central longitudinal axis. The cutting member body has a shank portion adjacent the axial rearward end thereof, and the shank portion has a generally smooth shank exterior surface. The cutting member body has a cutting portion adjacent to the axial forward end thereof, and the cutting portion has a cutting exterior surface containing one or more flutes. The cutting member body contains a coolant delivery passage wherein the coolant delivery passage comprises a primary cavity in the shank portion and a central coolant passage in the cutting portion and a plurality of lateral coolant passages in the cutting portion. The lateral coolant passages are in communication with the primary cavity through the central coolant passage, and each of the lateral coolant passages has an open end through which coolant exits the cutting member in the vicinity of the interface between the cutting member and the workpiece. The cutting portion is of a first grade of hard material, and the shank portion is of a second grade of hard material wherein the first grade of hard material is different from the second grade of hard material.

### BRIEF DESCRIPTION OF THE DRAWINGS

The following is a brief description of the drawings that form a part of this patent application:

FIG. 1 is a side view of a first specific embodiment of an end mill;

FIG. 2 is a cross-sectional view of a second specific embodiment of an end mill taken along section line 2-2 of FIG. 1;

FIG. 3 is a cross-sectional view of a fourth specific embodiment of an end mill;

FIG. 4 is a side view of a specific embodiment of a drill; and

FIG. 5 is a cross-sectional view of the drill of FIG. 4 taken along section line 5-5 of FIG. 4.

### DETAILED DESCRIPTION OF THE INVENTION

The present invention pertains to an injection molded (or cold isostatically pressed) cutting member with coolant delivery, as well as a composite rod blank that can be processed into the cutting member. More specifically, the present invention pertains to an injected molded (or cold isostatically pressed) cutting member, such as for example, a drill or end mill, with coolant delivery, as well as a composite rod blank that can be processed into the cutting member, wherein coolant exits the cutting member in the vicinity of the axial forward end thereof.

As will become apparent, the composite rod blank has a hollow shank, internal coolant passages, and net near shape external flutes. The composite rod blank uses a low cost powder material (e.g., cemented (cobalt) tungsten carbide) for the shank portion and a premium, higher cost powder material (e.g., cemented (cobalt) tungsten carbide) for the cutting portion. These features provide advantages connected with the use of the composite rod blank to make a cutting member such as, for example, an end mill or a drill.

One of the advantages connected with the use of the composite rod blank is the use of less material to make the composite rod blank, and hence, a lower cost due to material cost savings. The features of the composite rod blank that result in using less material are the use of a hollow shank, internal coolant passages, and net near shape external flutes. Each of these features requires the use of less material. Further, the use of a low cost powder material for the shank portion and a premium, higher cost powder material for the cutting portion reduces the cost of the powder material without sacrificing the performance of the cutting member. Another reduction in the overall cost to make the composite rod blank is due to the reduction in the amount of green machining necessary. The reduction in the amount of green machining is due to the use of a hollow shank and internal coolant passages, and to some extent the formation of net near shape external flutes. Less finish machining is necessary because of the formation of the near net shape external flutes.

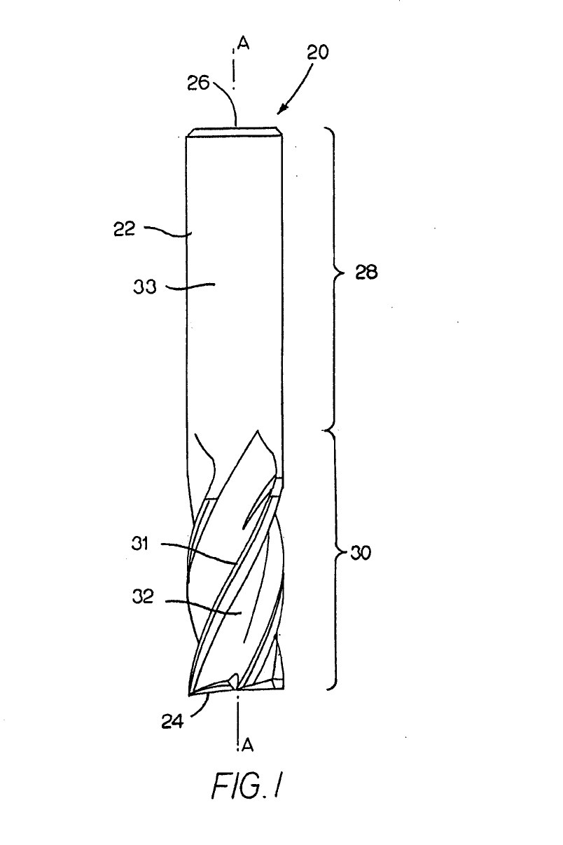

FIG. 1 illustrates a first specific embodiment of cutting member in the form of an end mill generally designated as 20. End mill 20 has an end mill body 22 with an axial forward end 24 and an axial rearward end 26. The end mill body 22 has a central longitudinal axis A-A. The end mill body 22 has a shank portion 28 adjacent to the axial rearward end 26 and a cutting portion 30, which has a cutting edge 31 and flutes 32, adjacent to the axial forward end 24. The end mill 20 is the result of processing an injected molded or cold-isostatically pressed composite rod blank.

The shank portion 28 has generally smooth surface 33 so that after the sintering process, minimal or no finish grinding is necessary. The cutting portion 30 has a more complex exterior geometry because of the cutting edges 31 and flutes 32. Because an injection molding technique (or cold isostatic pressing technique) is used to make the composite rod blank, only a minimal amount of finish grinding of the sintered part (composite rod blank) is necessary to complete the cutting portion 30. A reduction in the extent of finish grinding of the sintered part reduces the overall cost of manufacture of the cutting member. The above comments about the shank portion 28 and the cutting portion 30 of end mill 20 are applicable to the shank portion and cutting portion of the other specific embodiments of cutting members (e.g., end mills or drills) set forth herein.

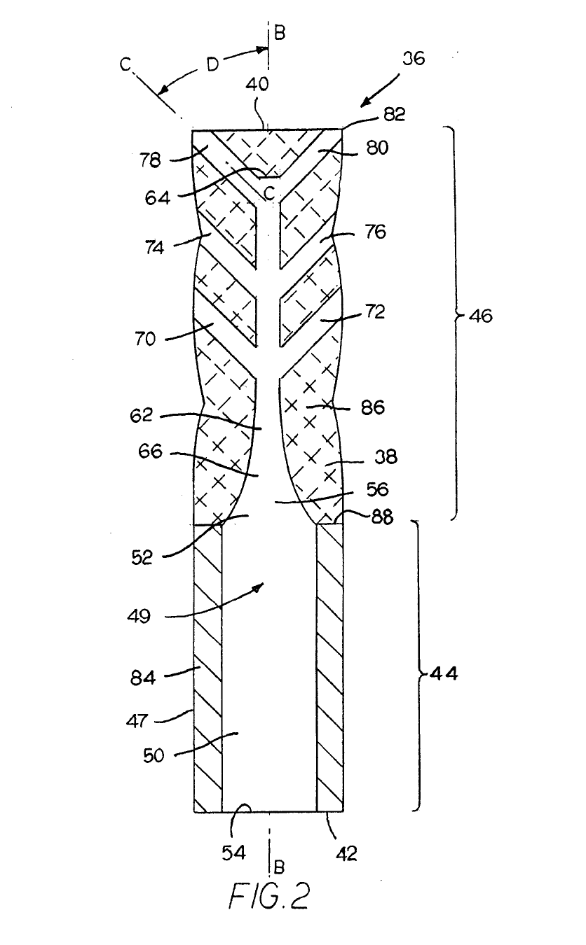

Referring to FIG. 2, there is shown a second specific embodiment of the injection molded end mill (or cutting member) with coolant delivery generally designated as 36. End mill body 38 has a central longitudinal axis B-B. There should be an appreciation that the end mill can be made by a cold isostatic pressing technique. End mill 36 has an end mill body 38 that has an axial forward end 40 and an axial rearward end 42. The end mill body 38 has a shank portion 44 adjacent to the axial rearward end 42 and a cutting portion 46 adjacent to the axial forward end 40. The shank portion 44 has a generally smooth exterior surface 47. The cutting portion 46 has cutting edges and flutes. Minimal finishing grinding is necessary to complete the cutting portion. There should be an appreciation that the use of the injection molding process provides for the formation of flutes or cutting edges at the axial forward end 40 of the body 38 of the injection molded end mill (or cutting member) with coolant delivery while leaving the portion adjacent the axial rearward end generally smooth. Some finish grinding of the shank portion adjacent the axial rearward end may be necessary to provide for precision in the cutting member being held or retained by clamping. The same advantage exists for a cold isostatic pressing process. The use of either process provides an advantage of requiring less finish grinding than with earlier articles which results in a labor and material saving.

The end mill body 38 contains a coolant delivery passage generally designated as 49. Coolant delivery passage 49 has a primary cavity 50 that opens at the axial rearward end 42 thereof wherein the primary cavity 50 has an axial forward cavity end 52 and an axial rearward cavity end 54. The coolant delivery passage 49 further includes a converging section 56 and a central coolant passage 62 that has an axial forward central coolant passage end 64 and an axial rearward central coolant passage end that is adjacent to the converging section 56. The converging section 56 joins the primary cavity 50 and the central coolant passage 62 so that there is fluid communication there between. A plurality of axially spaced apart angular lateral coolant passages (70, 72, 74, 76, 78, 80) are in communication with the central coolant passage 62 so as to receive coolant from the central coolant passage 62. Each of the axially spaced apart angular lateral coolant passages (70, 72, 74, 76, 78, 80) terminates in an open end through which coolant exits the end mill 36. For example, lateral coolant passage 80 terminates in open end 82.

The volume of the primary cavity 50 is greater than the volume of the central coolant passage 62 and the angular lateral coolant passages (70, 72, 74, 76, 78, 80). There should be an appreciation that the portion of the coolant delivery passage 49 located in the shank portion has a larger volume than the portion of the coolant delivery passage 49 located in the cutting portion wherein the results in a reduction of the amount of material necessary to make the injection molded (or cold isostatic pressed) end mill (or cutting member) with coolant delivery, as well as faster binder removal from the composite rod blank during the post-injection molding processing.

In reference to the orientation of the angular lateral passage 78, which has a central longitudinal axis C-C, it is disposed at angle D with respect to the central longitudinal axis B-B of the end mill body 38. Angle D is equal to about 45°, which is less than 90°. In this specific embodiment, the remaining angular lateral passages (70, 72, 74, 76, 80) are disposed at the same angle D with respect to the central longitudinal axis B-B of the end mill body 38. There is, however, the contemplation that the orientation of the angular lateral passages may be different depending upon the specific application and the coolant delivery requirements for the specific application. In looking at the orientation of the angular lateral passages, there should be an appreciation that the use of the injection molding process provides for the formation of a plurality of lateral coolant passages that split away from the central coolant passage in the vicinity of the axial forward end of the body of the injection molded end mill (or cutting member) with coolant delivery. This feature provides for an enhanced ability of the injection molded end mill (or cutting member) with coolant delivery to deliver coolant to the interface with the material being cut.

The shank portion 44 of the end mill body 38 is made from a shank grade of cemented carbide 84. The cutting portion 46 of the end mill body 38 is made from a cutting grade of cemented carbide 86. There is a boundary 88 at the juncture of the shank grade of cemented carbide 84 and the cutting grade of cemented carbide 86. The shank grade of cemented carbide 84 is a less costly grade of cemented carbide than the cutting grade of cemented carbide 86, which is a more costly premium grade of cemented carbide. Therefore, the boundary 88 is the boundary between the less costly grade of cemented carbide and the more costly grade of cemented carbide. This boundary 88 coincides with the division of the cutting member body 38 into the shank portion 44 and the cutting portion 46.

As mentioned above, the cutting grade of cemented carbide is different from the shank grade of cemented carbide wherein the cutting grade of cemented carbide is more of a premium/higher cemented carbide grade while the shank grade of cemented carbide is a lower/less costly grade of cemented carbide. As one alternative, the shank grade of cemented (cobalt) tungsten carbide comprises between about 5 weight percent and about 15 weight percent cobalt, cubic carbides (e.g., titanium carbide, tantalum carbide, niobium carbide, vanadium carbide, chromium carbide) in an amount greater than zero weight percent and less than about 15 weight percent, and tungsten carbide in an amount between about 70 weight percent and about 95 weight percent. The tungsten carbide has a grain size between about 1 micron and about 10 micron. This grade of cemented tungsten carbide is suitable to be the shank portion 44 of the end mill body 38.

One alternative for the cutting grade of cemented (cobalt) tungsten carbide has a composition comprising between about 5 weight percent and about 15 weight percent cobalt, between greater than zero weight percent and less than about 1 weight percent cubic carbides (e.g., titanium carbide, tantalum carbide, niobium carbide, vanadium carbide, chromium carbide), and tungsten carbide present in an amount between about 84 weight percent and about 95 weight percent. The tungsten carbide has a grain size less than about 2 microns. As another alternative, the cutting grade of cemented carbide 86 has a composition of between about 88 weight percent and about 92 weight percent tungsten carbide of a grain size equal to between about 0.8 microns and about 3 microns, and between about 8 weight percent and about 12 weight percent cobalt, and may further comprise between about 0.2 weight percent and about 1 weight percent of one or more elements selected from the group consisting essentially of chromium and vanadium. The cutting grade of cemented (cobalt) tungsten carbide has properties that make it suitable to be the cutting portion 46 of the end mill body 38. The cutting grade of cemented (cobalt) tungsten carbide is more costly than the shank grade of cemented (cobalt) tungsten carbide. There should also be an appreciation that the use of different grades of hard material (e.g., cemented (cobalt) tungsten carbide results in maintaining performance characteristics, and yet, experiencing cost savings in that a more costly premium cemented (cobalt) tungsten carbide, which is more suitable for cutting, can form the cutting portion adjacent the axial forward end and a less costly grade of cemented (cobalt) tungsten carbide can form the shank portion adjacent the axial rearward end of the injection molded end mill (or cutting member) with coolant delivery.

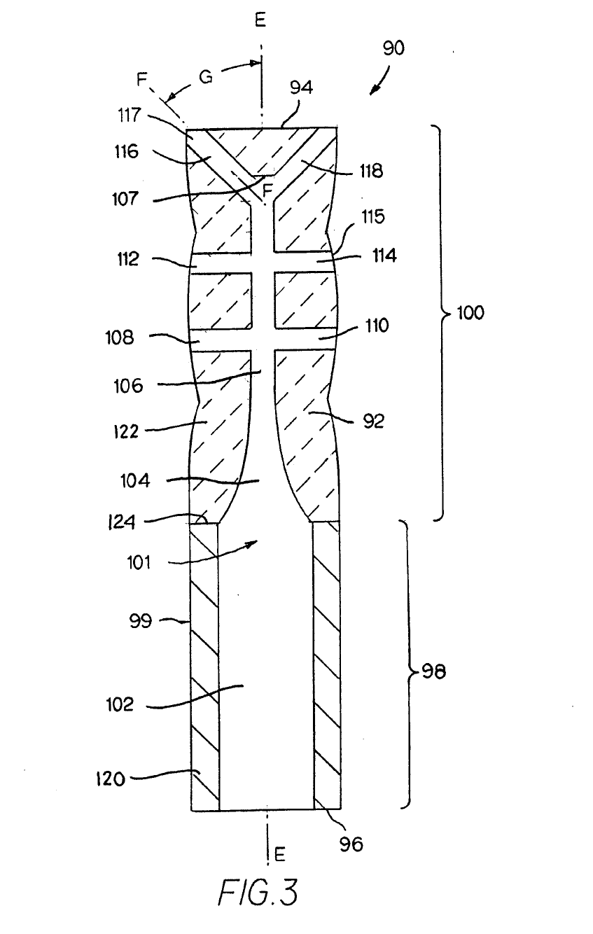

Referring to FIG. 3, there is shown a third specific embodiment of the injection molded end mill (or cutting member) with coolant delivery generally designated as 90. End mill 90 has an end mill body 92 that has an axial forward end 94 and an axial rearward end 96. End mill body 92 has a central longitudinal axis E-E. The end mill body 92 has a shank portion 98 adjacent to the axial rearward end 96 and a cutting portion 100 adjacent to the axial forward end 94. The shank 98 has a generally smooth exterior surface 99.

The end mill body 92 contains a coolant delivery passage generally designated as 101. Coolant delivery passage 101 includes a primary cavity 102 that opens at the axial rearward end 96 thereof. The coolant delivery passage 101 further includes a converging section 104 and a central coolant passage 106 that has an axial forward central coolant passage end 107. The converging section 104 joins the primary cavity 102 and the central coolant passage 106 so that there is fluid communication between the primary cavity 102 and the central coolant passage 106. The end mill body 92 contains a plurality of axially spaced apart transverse lateral coolant passages (108, 110, 112, 114) that are in fluid communication with the central coolant passage 106 so as to receive coolant from the central coolant passage 106. Each of the axially spaced apart transverse lateral coolant passages (108, 110, 112, 114) terminates in an open end through which coolant exits the end mill 90. Transverse lateral coolant passage 114 terminates in an open end 115. Further, the end mill body 92 contains a plurality of angular lateral coolant passages (116, 118) adjacent the axial forward end 94. Each of the angular lateral coolant passages (116, 118) are in fluid communication with the central coolant passage 106 so as to receive coolant from the central coolant passage 106. Each of the angular lateral coolant passages (116, 118) terminates in an open end through which coolant exits the end mill 90. Angular lateral coolant passage 116 terminates in an open end 117.

In reference to the orientation of the angular lateral passage 116, which has a central longitudinal axis F-F, it is disposed at angle G with respect to the central longitudinal axis E-E of the end mill body 92. Angle G is equal to about 45°, which is less than 90°. In this specific embodiment, the remaining angular lateral passage 118 is disposed at the same angle G with respect to the central longitudinal axis E-E of the end mill body 92. There is, however, the contemplation that the orientation of the angular lateral passages may be different depending upon the specific application and the coolant delivery requirements for the specific application.

The shank portion 98 of the end mill body 92 is made from a shank grade of cemented carbide 120. The cutting portion 100 of the end mill body 92 is made from a cutting grade of cemented carbide 122. There is a boundary 124 at the juncture of the shank grade of cemented carbide 120 and the cutting grade of cemented carbide 122. This boundary 124 coincides with the division of the end mill body 92 into the shank portion 98 and the cutting portion 100.

The cutting grade of cemented carbide is different from the shank grade of cemented carbide wherein the cutting grade of cemented carbide is more of a premium/higher cemented carbide grade while the shank grade of cemented carbide is a lower/less costly grade of cemented carbide. As one alternative, the shank grade of cemented (cobalt) tungsten carbide comprises between about 5 weight percent and about 15 weight percent cobalt, cubic carbides (e.g., titanium carbide, tantalum carbide, niobium carbide, vanadium carbide, chromium carbide) in an amount between greater than zero weight percent and less than about 15 weight percent, and tungsten carbide in an amount between about 70 weight percent and about 95 weight percent. The tungsten carbide has a grain size between about 1 micron and about 10 micron. This grade of cemented carbide is suitable to be the shank portion 98 of the end mill body 92.

One alternative for the cutting grade of cemented (cobalt) tungsten carbide has a composition comprising between about 5 weight percent and about 15 weight percent cobalt, between greater than zero weight percent and less than about 1 weight percent cubic carbides (e.g., titanium carbide, tantalum carbide, niobium carbide, vanadium carbide, chromium carbide), and tungsten carbide present in an amount between about 84 weight percent and about 95 weight percent. The tungsten carbide has a grain size less than about 2 microns. As another alternative, the cutting grade of cemented carbide 122 has a composition of between about 88 weight percent and about 92 weight percent tungsten carbide of a grain size equal to between about 0.8 microns and about 3 microns, and between about 8 weight percent and about 12 weight percent cobalt, and may further comprise between about 0.2 weight percent and about 1 weight percent of one or more elements selected from the group consisting essentially of chromium and vanadium. The cutting grade of cemented (cobalt) tungsten carbide has properties that make it suitable to be the cutting portion 100 of the end mill body 92.

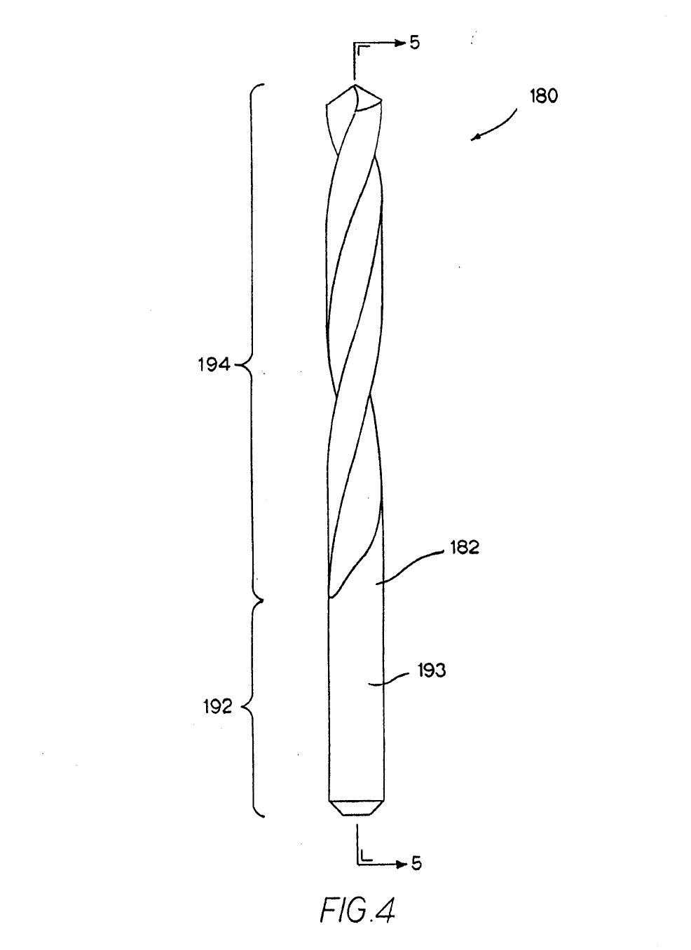

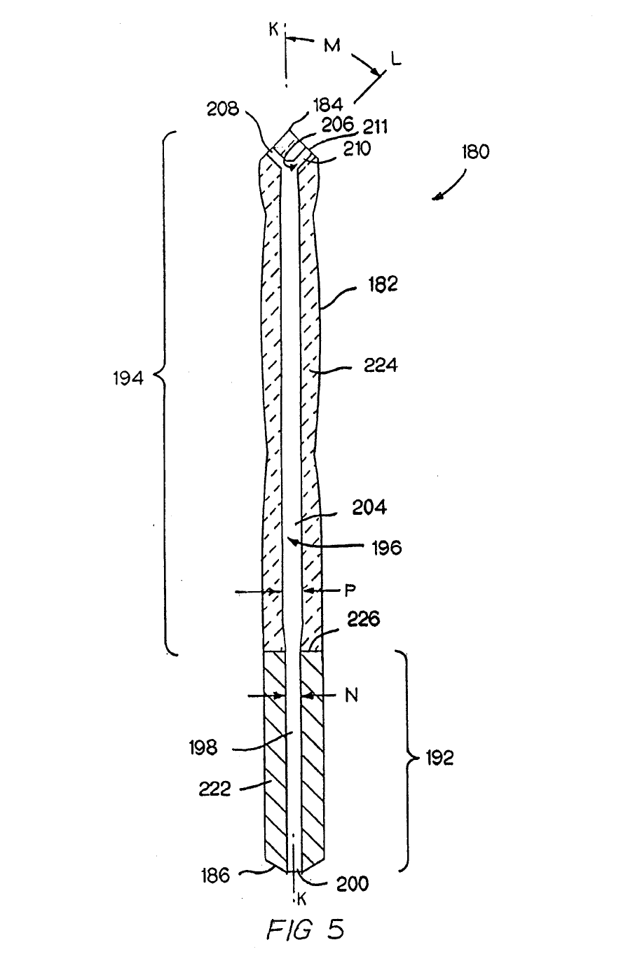

Referring to FIGS. 4 and 5, there is shown a specific embodiment of a drill (or cutting member) with coolant delivery generally designated as 180. Drill 180 has a drill body 182 that has an axial forward end 184 and an axial rearward end 186. Drill body 182 has a central longitudinal axis K-K. The drill body 182 has a shank portion 192 adjacent to the axial rearward end 186 thereof, and a cutting portion 194 adjacent to the axial forward end 184 thereof. The shank portion 192 has a smooth exterior surface 193.

The drill body 182 contains a coolant delivery passage 196 that includes a primary cavity 198 that has an axial rearward cavity end 200. The primary cavity 198 is of a cylindrical geometry and has a diameter “N”. The coolant delivery passage 196 further includes a central coolant passage 204 that has an axial forward central coolant passage end 206. The drill body 182 contains angular lateral coolant passages (208, 210) adjacent to the axial forward central coolant passage end 206. Angular lateral coolant passage 208 has a central longitudinal axis L-L. The angular lateral coolant passage 208 is oriented at an angle “M” relative to a line perpendicular to the central longitudinal axis K-K of the drill body 182. There is, however, the contemplation that the orientation of the angular lateral passages may be different depending upon the specific application and the coolant delivery requirements for the specific application.

The central coolant passage 204 is of a diameter “P”. The diameter “P” of the central coolant passage 204 is larger than the diameter “N” of the primary cavity 198. The central coolant passage 196 has a larger volume than the volume of the primary cavity 198.

The shank portion 192 of the drill body 182 is made from a shank grade of cemented carbide 222. The cutting portion 194 of the drill body 182 is made from a cutting grade of cemented carbide 224. There is a boundary 226 between the shank grade of cemented carbide 222 and the cutting grade of cemented carbide 224. This boundary 226 coincides with the division of the drill body 182 into the shank portion 192 and the cutting portion 194.

The cutting grade of cemented carbide is different from the shank grade of cemented carbide wherein the cutting grade of cemented carbide is more of a premium/higher cemented carbide grade while the shank grade of cemented carbide is a lower/less costly grade of cemented carbide. As one alternative, the shank grade of cemented (cobalt) tungsten carbide comprises between about 5 weight percent and about 15 weight percent cobalt, cubic carbides (e.g., titanium carbide, tantalum carbide, niobium carbide, vanadium carbide, chromium carbide) in an amount between greater than zero weight percent and less than about 15 weight percent, and tungsten carbide in an amount between about 70 weight percent and about 95 weight percent. The tungsten carbide has a grain size between about 1 micron and about 10 micron. This grade of cemented carbide is suitable to be the shank portion 192 of the drill body 182.

One alternative for the cutting grade of cemented (cobalt) tungsten carbide has a composition comprising between about 5 weight percent and about 15 weight percent cobalt, between greater than zero weight percent and less than about 1 weight percent cubic carbides (e.g., titanium carbide, tantalum carbide, niobium carbide, vanadium carbide, chromium carbide), and tungsten carbide present in an amount between about 84 weight percent and about 95 weight percent. The tungsten carbide has a grain size less than about 2 microns. As another alternative, the cutting grade of cemented carbide has a composition of between about 88 weight percent and about 92 weight percent tungsten carbide of a grain size equal to between about 0.8 microns and about 3 microns, and between about 8 weight percent and about 12 weight percent cobalt, and may further comprise between about 0.2 weight percent and about 1 weight percent of one or more elements selected from the group consisting essentially of chromium and vanadium, and properties that make it suitable to be the cutting portion 194 of the drill body 182.

In reference to the process of making the composite rod blank that will be made into the cutting member (e.g., end mill or drill) with coolant delivery, the process is a co-injection molding process in which a hard material powder (e.g., cemented (cobalt) tungsten carbide) is mixed with waxes, polymers and surfactants to produce a thermoplastic feedstock for injection molding. The feedstock is molded in an injection molding machine at a temperature ranging between about 130° and about 165° C. and pressure between about 600 bar and about 1000 bar. The injection molding equipment includes moving components that allow for the creation of internal channels and the formation of external flutes. One should appreciate that in the injection molding process, hydraulic and/or mechanical action can be used to remove the cores. There should be an appreciation that the internal coolant holes can be made by a core, which can be removed or evaporated subsequent to injection molding or cold isostatic pressing.

The injection molded parts are subjected first to a solvent debinding process to removes the waxes which comprises immersion in heptanes at a temperature higher than the melting point of the wax in the binder system so as to allow for the dissolution of the wax from the injection molded compact over a period of between about 5 hours to about 20 hours depending upon the cross-section of the compact. The part is then subjected to a thermal debinding process under hydrogen to pyrolize the polymers in the binder system. The parts are then sintered in a sinter HIP process at a temperature of between about 1400° C. and about 1470° C. and a pressure of between about 12 bar and about 70 bar. The composite rod blank is finish ground to meet finish tolerances for a cutting member (e.g., an end mill or a drill). There should be an appreciation that the use of the injection molding process provides for the formation of a plurality of lateral coolant passages that split away from the central coolant passage in the vicinity of the axial forward end of the body of the injection molded end mill (or cutting member) with coolant delivery. This feature provides for an enhanced ability of the injection molded end mill (or cutting member) with coolant delivery to deliver coolant to the interface with the material being cut.

There should also be an appreciation that the use of the injection molding process provides for the formation of flutes or cutting edges at the axial forward end of the body of the injection molded end mill (or cutting member) with coolant delivery while leaving the portion adjacent the axial rearward end generally smooth so as to be suitable for being held or retained by clamping. This provides an advantage of requiring only finish grinding of the outer geometry, and not substantial grinding of the portion adjacent the axial rearward end, which results in a labor and material saving.

Further, there should be an appreciation that the coolant delivery passage located in the shank portion has a larger volume than the coolant delivery located in the cutting portion wherein the results in a reduction of the amount of material necessary to make the injection molded end mill (or cutting member) with coolant delivery, as well as faster binder removal during the post-injection molding processing.

There should also be an appreciation that the use of different grades of hard material (e.g., cemented (cobalt) tungsten carbide results in maintaining performance characteristics while still experiencing cost savings in that a more costly premium cemented (cobalt) tungsten carbide, which is more suitable for cutting, can form the cutting portion adjacent the axial forward end and a less costly grade of cemented (cobalt) tungsten carbide can form the shank portion adjacent the axial rearward end of the injection molded end mill (or cutting member) with coolant delivery.

It can therefore be appreciated that the cutting member is made from a composite rod blank that has a hollow shank, internal coolant passages, and net near shape external flutes. The composite rod blank uses a low cost powder material (e.g., cemented (cobalt) tungsten carbide) for the shank portion and a premium, higher cost powder material (e.g., cemented (cobalt) tungsten carbide) for the cutting portion. These features provide advantages connected with the use of the composite rod blank to make a cutting member such as, for example, an end mill or a drill.

One of the advantages connected with the use of the composite rod blank is the use of less material to make the composite rod blank, and hence, a lower cost due to material cost savings. The features of the composite rod blank that result in using less material are the use of a hollow shank, internal coolant passages, and net near shape external flutes. Each of these features requires the use of less material. Further, the use of a low cost powder material for the shank portion and a premium, higher cost powder material for the cutting portion reduces the cost of the powder material without sacrificing the performance of the cutting member. Another reduction in the overall cost to make is due to the reduction in the amount of green machining necessary. The reduction in the amount of green machining is due to the use of a hollow shank and internal coolant passages, and to some extent the formation of net near shape external flutes. Less finish machining is necessary because of the formation of the near net shape external flutes.

The patents and other documents identified herein are hereby incorporated by reference herein. Other embodiments of the invention will be apparent to those skilled in the art from a consideration of the specification or a practice of the invention disclosed herein. It is intended that the specification and examples are illustrative only and are not intended to be limiting on the scope of the invention. The true scope and spirit of the invention is indicated by the following claims.

What is claimed is:

1. A cutting member with coolant delivery comprising:
a cutting member body having an axial forward end and an axial rearward end, the cutting member body having a central longitudinal axis;
the cutting member body having a shank portion adjacent the axial rearward end thereof, and the shank portion having a shank exterior surface; and cutting member body having a cutting portion adjacent to the axial forward end thereof, and the cutting portion having a cutting exterior surface containing one or more cutting edges;
the cutting member body containing a coolant delivery passage wherein the coolant delivery passage comprises a primary cavity in the shank portion and a central coolant passage in the cutting portion and a plurality of lateral coolant passages in the cutting portion, and the lateral coolant passages being a communication with the primary cavity through the central coolant passage, and each of the lateral coolant passages having an open end through which coolant exits the cutting member; and
the cutting portion being of a cutting grade of hard material, and the shank portion being of a shank grade of hard material, and wherein the cutting grade of hard material is different from the shank grade of hard material.

2. The cutting member with coolant delivery according to claim 1 wherein the lateral coolant passages include a plurality of angular coolant passages disposed at an angle less than 90 degrees with respect to the central longitudinal axis of the cutting member body.

3. The cutting member with coolant delivery according to claim 1 wherein the lateral coolant passages include a plurality of generally transverse coolant passages disposed at an angle of about 90 degrees with respect to the central longitudinal axis of the cutting member body.

4. The cutting member with coolant delivery according to claim 1 wherein the lateral coolant passages include a plurality of angular coolant passages disposed at an angle less than 90 degrees with respect to the central longitudinal axis of the cutting member body and a plurality of generally transverse coolant passages disposed at an angle of about 90 degrees with respect to the central longitudinal axis of the cutting member body.

5. The cutting member with coolant delivery according to claim 1 wherein the coolant delivery passage further includes a converging section that joins the primary cavity and the central coolant passage.

6. The cutting member with coolant delivery according to claim 1 wherein the cutting grade of hard material is a cutting grade of cemented carbide and the shank grade of hard material is a shank grade of cemented carbide, and wherein the cutting grade of cemented carbide is different from the shank grade of cemented carbide.

7. The cutting member with coolant delivery according to claim 6 wherein the cutting grade of cemented carbide comprises tungsten carbide in an amount between about 84 weight percent and about 95 weight percent, cobalt in an amount between about 5 weight percent and about 15 weight percent and between greater than zero weight percent and less than about 1 weight percent cubic carbides, and the tungsten carbide has an average grain size of less than 2 microns; and the shank grade of cemented carbide comprises tungsten carbide in an amount between about 70 weight percent and about 95 weight percent, cobalt in an amount between about 5 weight percent and about 15 weight percent, cubic carbides present in an amount between greater than zero weight percent and about 15 weight percent, and the tungsten carbide has an average grain size of 1-10 microns.

8. The cutting member with coolant delivery according to claim 7 wherein the cutting grade of cemented carbide comprises between about 88 weight percent and about 92 weight percent tungsten carbide of a grain size equal to between about 0.8 microns and about 3 microns, and between about 8 weight percent and about 12 weight percent cobalt.

9. The cutting member with coolant delivery according to claim 8 wherein the cutting grade of cemented carbide further contains between about 0.2 weight percent and about 1 weight percent of one or more elements selected from the group consisting essentially of chromium and vanadium.

10. The cutting member with coolant delivery according to claim 1 wherein the primary cavity is contained within the shank portion of the cutting member body, and the central coolant passage is contained within the cutting portion of the cutting member body, the primary cavity has a primary cavity volume, the central coolant passage has a central coolant passage volume.

11. The cutting member according to claim 10 wherein the primary cavity volume having a greater volume than the central coolant passage volume.

12. The cutting member with coolant delivery according to claim 10 wherein the primary cavity volume is less than the coolant passage volume.

13. A cutting member with coolant delivery wherein the cutting member is useful for material removal from a workpiece, the cutting member comprising:
a cutting member body having an axial forward end and an axial rearward end, the cutting member body having a central longitudinal axis,
the cutting member body having a shank portion adjacent the axial rearward end thereof, and the shank portion having a generally smooth shank exterior surface; and cutting member body having a cutting portion adjacent to the axial forward end thereof, and the cutting portion having a cutting exterior surface containing one or more flutes;
the cutting member body containing a coolant delivery passage wherein the coolant delivery passage comprises a primary cavity in the shank portion and a central coolant passage in the cutting portion and a plurality of lateral coolant passages in the cutting portion, and the lateral coolant passages being a communication with the primary cavity through the central coolant passage, and each of the lateral coolant passages having an open end through which coolant exits the cutting member in the vicinity of the interface between the cutting member and the workpiece; and
the cutting portion being of a cutting grade of hard material, and the shank portion being of a shank grade of hard material, and wherein the cutting grade of hard material is different from the shank grade of hard material.

14. The cutting member with coolant delivery according to claim 13 wherein the lateral coolant passages include a plurality of angular coolant passages disposed at an angle less than 90 degrees with respect to the central longitudinal axis of the cutting member body, and the angular coolant passages exit adjacent the axial forward end of the cutting member body.

15. The cutting member with coolant delivery according to claim 13 wherein the primary cavity is contained within the shank portion of the cutting member body, and the central coolant passage is contained within the cutting portion of the cutting member body, the primary cavity has a primary cavity volume, the central coolant passage has a central coolant passage volume.

16. The cutting member with coolant delivery according to claim 15 where the primary cavity volume being greater volume than the central coolant passage volume.

17. The cutting member with coolant delivery according to claim 15 where the primary cavity volume being lesser volume than the central coolant passage volume.
